(19) United States
(12) Patent Application Publication
(10) Pub. No.: US 2024/0239397 A1
(43) Pub. Date: Jul. 18, 2024

(54) Golfing Push Cart with Child Seat

(71) Applicant: Benjamin T. Foley, Boston, MA (US)

(72) Inventor: Benjamin T. Foley, Boston, MA (US)

(21) Appl. No.: 17/305,765

(22) Filed: Jul. 14, 2021

(51) Int. Cl. B62B 9/12; A63B 55/60; B62B 9/20

(52) U.S. Cl. CPC B62B 9/12; A63B 55/60; B62B 9/20; B62B 7/14

(57) ABSTRACT

A golfing push cart with child seat is disclosed. The apparatus is comprised of a collapsible, golfing push cart having at least three wheels with a selectively-removable child seat thereon. The push cart has a top support that engages said seat from underneath. The seat has a locking belt and expanding canopy to keep a child in place and protect them from weather and stray balls. An object of the apparatus is to provide a means to allow users to have one or more of their children join them on the golf course.

### FIELD OF THE INVENTION

The present invention generally relates to childcare. More specifically, it relates to a system that allows users to engage in a casual game of golf while at the same time allowing them to care for one or more children on the course.

### BACKGROUND

Before the 1960s, most golf courses were played exclusively on foot and golfers carried their own bags. Affluent golfers were able to play golf at country clubs that provided caddies available to carry their clubs. One of the very first known golf bag carts was known as the ‘Pull Cart,’ and it was designed and manufactured by Bruce Williamson in the United States in 1945. His original golf pull cart had hard rubber tires mounted on a spring-suspension chassis with a fold-down mechanism that supported standard golf bags. Mr. Williamson acquired a business partner, E. Roy Jarman, and they formed the Jarman-Williamson Company in 1946. They began producing these basic golf pull carts from a combination of aluminum tubing and sand-casted metal parts. All of the parts in the design were connected with bolts so as to make it easy to replace any damaged parts, which consequently made the cart last longer and alleviate costly repairs. A metal die-casting process was introduced into the manufacturing process in 1947 to enhance the quality of the metal components. Round-shaped zero pressure tires on dish wheels were added to the folding chassis mechanism at that time. In 1957, Bruce Williamson sold his interest to Roy Jarman, but the company name was retained until 1967 when it was changed to The Jarman Company. By then, the company was marketing its own golf cart bag, the “Cart-Mate,” which was designed to attach to the pull cart by means of a few part changes.

In 1993, AMF Industries bought the Jarman Company and relocated it to Richmond, Virginia making it a division of The Ben Hogan Company. Later on in 1997 the Hogan Company was sold to Spalding, a very well established sporting goods company. In 2002, the Company became known as the Bag Boy Golf Cart Company. At this time, they developed the first-ever push golf cart. This new innovation cart was designed to be pushed in front of the golfer, providing a new means to walk the course in comfort and relaxation. This change was a very meaningful improvement to the Golf Bag Cart development in general. The Bag Boy golf push cart quickly gained acceptance and accelerated the industry-wide transition from pull carts to push carts. Although pull carts are still available, 80% of Bag Boy carts sold today are golf push carts.

Many in the golf industry have been developing different variations of devices that can be used to carry golf bags. U.S. Pat. No. 6,863,297, U.S. Ser. No. 10/850,760 granted to Shapiro and Richard Neal Shapiro, Gordon Liao, and Thomas Reiter respectively disclosed a cart that could be used to carry either a baby or other things such as golf bags; however, these patents are for use of the cart as either a baby carriage, or a golf push cart, or a cart used for carrying other things, and do not allow for simultaneous use of the cart as both a stroller and a golf push cart As golfing push carts continue to evolve, many in the industry are looking at ways of allowing them to take on multiple purposes. Canadian Patent No. CA2614760A1 and U.S. Pat. No. 8,857,847B2 granted to Mark and Judy Watson and Jean-Pierre Joubert respectively, disclosed a cart that also has a rack to carry an athletic accessory; however, these patents don't include onboard miniature changing tables, onboard storage totes, or an overheard canopy to protect the child. These patents also don't allow for more than one child or more than one child's seat to be used on the device. What is needed is a golfing push cart that has the ability to install one or more removable child carriers that allow players to bring their youngsters to the golf course. What is also needed is a multifunctional combinatory golfing push cart and children's stroller device that includes protective equipment for the child, a miniature baby changing station, and onboard storage space.

### SUMMARY OF THE INVENTION

The device herein disclosed and described provides a solution to the shortcomings in the prior art through the disclosure of a golfing push cart with one of more onboard child seats. An object of the apparatus is to allow users to feel that they can safely bring one or more children or infants to a golf course and partake in the sport. The push cart has one or more child seats that contain standard restraints so that the children remain secure and do not leave the parent's vicinity.

Another object of the invention is to provide a means to protect a child that is sitting in the golfing push cart. The child seat has an expanding canopy that can cover the child and can withstand wind, rain and the occasional stray ball.

Another object of the invention is to allow a golf push cart to be modular. The cart has a connection platform that allows the child seat to be easily secured and also disconnected from the apparatus when no longer needed.

Another object of the invention is to allow the system to be easily transported and stored when not in use. The golf push cart can be folded up and fits into a vehicle or closet easily.

It is briefly noted that upon reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. The phrase “consisting of” is meant including, and limited to, whatever follows the phrase “consisting of”. Thus, the phrase “consisting of” indicates that the listed elements are required or mandatory, and that no other elements may be present.

The phrase “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a side view of the golfing push cart.

FIG. 2 shows a perspective view of another embodiment of the apparatus.

FIG. 3 shows a perspective view of an embodiment of the apparatus.

FIG. 4 shows a rear view of the apparatus.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

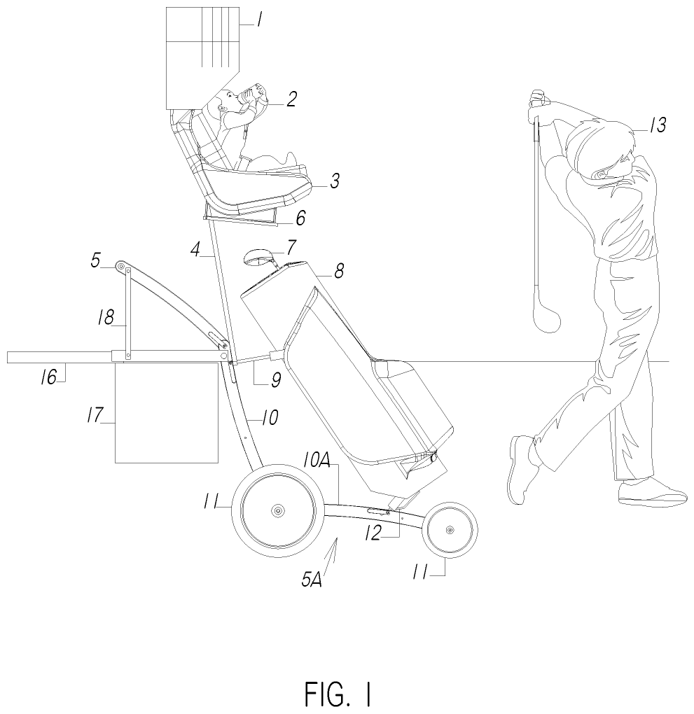

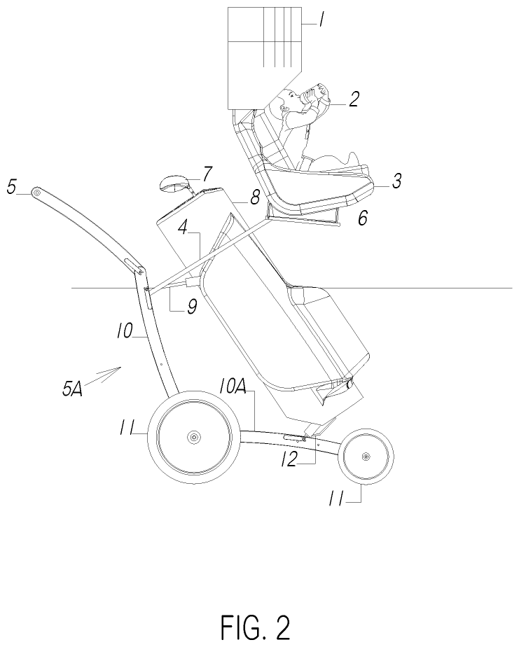

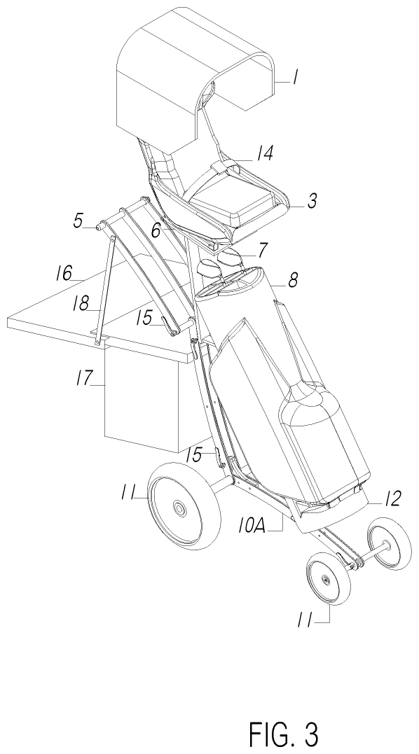

FIG. 1 shows a view of an embodiment of a golfing push cart with baby seat 3 positioned atop along with baby 2 and parent golfer 13. FIG. 2 shows the preferred embodiment of the golfing push cart with baby seat 3 positioned on front. The figures show the apparatus being comprised of a carriage assembly 5A (further comprised of upper bracket 10 and lower bracket 10A) and a conventional, baby seat 3. Other embodiments of the golfing push cart can have baby seat 3 configured in other locations including but not limited to behind, in front of and below carriage assembly 5A. Said baby seat 3 being detachably-connected to said carriage assembly 5A by means of a proprietary mounting platform 6 (rigidly affixed to metal post 4 that is also rigidly affixed to upper bracket 10) and the baby seat 3 also having an expandable canopy 1. Expandable canopy 1 is comprised of pivotably-connected, square-shaped rods supporting nylon or vinyl sheeting that can expand and contract covering said baby seat 3 there atop. The proprietary mounting platform 6 comprised of square-shaped, rigid brackets (made of a metal) and having fastening attachments that are defined as but are not limited to: bolts; interlocking detents; quick disconnect pins and the like that engage mating anchoring elements (defined as but not limited to; nuts; female detent apertures; quick disconnect pin apertures etc.) on the bottom side of said baby seat 3. The baby seat 3 being defined as any form of seating arrangement that forms a seat for a child or infant comprised of but not limited to: a rigid chair form made of plastic and the like and having cushioning with cloth material therein. The baby seat also having a multitude of restraints 14 (being made of nylon and the like) that can include waist and/or shoulder straps with buckles. The embodiment shown in FIGS. 1, 3, and 4 show the apparatus having a telescoping, mini changing table 16 being supported by at least two side braces 18 attached to push handle 5. Said expandable tote 17 being rigidly affixed to expandable tote 17 by means of fasteners. Other embodiments of the invention can have more than one baby seat 3—for example, the apparatus may have one baby seat 3 above the carriage assembly and one in front.

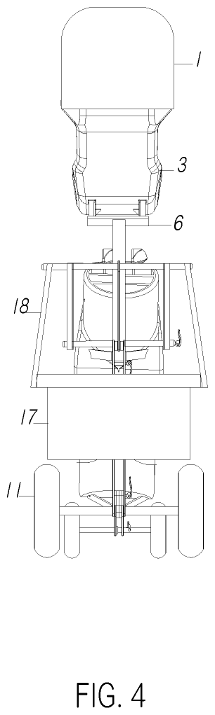

FIGS. 2 and 4 showing other views of the golfing push cart having a plurality of wheels 11 (made of a rigid yet flexible made of plastic etc.) and being connected to said carriage assembly 5A by means of cylindrical, metal, axles 11A that are perpendicular to the longitudinal axis of carriage assembly 5A. The upper bracket 10 and lower bracket 10A being rectangular-shaped and are pivotally-connected to one another at terminal ends with locking handles 15. Other embodiments can include bolts and fasteners etc. One end of upper bracket 10 being connected to swiveling, push handle 5. Other embodiments can include a braking system with hand grips etc. Golf bag 8 being selectively secured to carriage assembly 5A by means of upper brace 9 (made of metal and having a saddle component) and lower brace 12 (also made of metal and having a saddle component). Other embodiments may include strapping that is installed around said golf bag 8 and fixedly connected to upper brace 8 and lower brace 12.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A golfing push cart comprised of the following parts:
a) A carriage assembly;
b) One or more baby seats;
d) A telescoping, mini changing table;
e) An expandable tote; and
f) Proprietary mounting platform for attaching baby seats to carriage assembly.

2. The golfing push cart of claim 1, wherein the carriage assembly having an upper bracket and a lower bracket connected with locking handles.

3. The golfing push cart of claim 1, wherein the carriage assembly having a plurality of wheels with axles.

4. The golfing push cart of claim 1, wherein the carriage assembly having a push handle.

5. The golfing push cart of claim 1, wherein the carriage assembly having an upper brace and lower brace with saddle components to hold golf bags.

6. The golfing push cart of claim 1, wherein the carriage assembly having a mounting platform with post and attachments to hold baby seat.

7. The golfing push cart of claim 1, wherein the baby seat having restraints and mating anchoring elements to connect the baby seat to the carriage assembly.

8. The golfing push cart of claim 1, wherein the baby seat having an expanding canopy with rods and sheeting.

9. The golfing push cart of claim 1, wherein the telescoping, mini changing table is affixed to push handle with side braces.

10. The golfing push cart of claim 1, wherein the expandable tote 17 being rigidly affixed to expandable tote by means of fasteners.
